(19) United States
(12) Patent Application Publication
(10) Pub. No.: US 2011/0303881 A1
(43) Pub. Date: Dec. 15, 2011

(54) CARBOXY METHYL CELLULOSE AND SLURRY COMPOSITION WITH THE SAME

(75) Inventors: Jun Hee BAE, Gyeonggi-do (KR); Bae Kyun Kim, Gyeonggi-do (KR); Chang Ryul Jung, Seoul (KR)

(73) Assignee: SAMSUNG ELECTRO-MECHANICS CO., LTD.

(21) Appl. No.: 12/884,592

(22) Filed: Sep. 17, 2010

(30) Foreign Application Priority Data
Jun. 11, 2010 (KR) 10-2010-0055412

(51) Int. Cl. H01B 1/04; H01B 1/12

(52) U.S. Cl. 252/510; 252/500

(57) ABSTRACT

Disclosed herein is carboxy methyl cellulose of slurry composition for manufacturing an electrode for an energy storage device. The carboxy methyl cellulose according to the exemplary embodiment of the present invention has the viscosity of 100 to 500 cP in 1 wt % slurry composition.

### CROSS REFERENCE TO RELATED APPLICATION

This application claims the benefit of Korean Patent Application No. 10-2010-0055412, filed on Jun. 11, 2010, entitled “Carboxy Methyl Cellulose And Slurry Composition With The Same,” which is hereby incorporated by reference in its entirety into this application.

### BACKGROUND OF THE INVENTION

1. Technical Field

The present invention relates to carboxy methyl cellulose and slurry composition with the same, and more particularly, to carboxy methyl cellulose used as a binder among structural materials for a super capacitor electrode and slurry composition with the same.

2. Description of the Related Art

Generally, slurry composition for manufacturing an electrode for an energy storage device such as a rechargeable battery and a super capacitor may largely consist of three materials. As one example, the slurry composition for manufacturing the super capacitor electrode includes an activated carbon, a conductive material, and a binder. The binder is provided to increase capacity of the super capacitor electrode, electrode characteristics, and hardness and viscosity of slurry composition and improve simplicity of manufacturing of an electrode, or the like. As the binder used for manufacturing the super capacitor electrode, there is carboxy methyl cellulose (CMC).

FIG. 1 shows behavior characteristics of any one of slurry compositions for manufacturing an electrode for an energy storage device used in the related art, and FIG. 2 shows behavior characteristics of the other of slurry compositions for manufacturing the electrode for the energy storage device used in the related art. The slurry composition shown in FIG. 1 includes a CMC (hereinafter, referred to as a first CMC) having viscosity of about 10 cP or less in 1 wt % slurry composition. The slurry composition shown in FIG. 2 includes a CMC (hereinafter, referred to as a second CMC) having viscosity of about 1500 to 2000 cP in 1 wt % slurry composition.

Referring to FIG. 1, the slurry composition including the first CMC has a large difference between viscosity property under a condition (up) where a shear rate (rpm) is relatively increased and viscosity property under a condition (down) where a shear rate is relatively reduced. Since molecules of the first CMC are small and the viscosity thereof is relatively low, the behavior of the CMC adsorbed onto a powder, such as an activated carbon, etc., in a slurry state is similar to both the high shear rate and the low shear rate. As a result, it is determined that the above-mentioned phenomenon appears Therefore, sediment is generated in the slurry composition including the first CMC but degrades solution stability and when the slurry composition is coated on the surface of the current collector in order to manufacture the electrode, the phenomenon of the slurry composition occurs in that it is non-uniformly coated on the surface of the current collector.

Referring to FIG. 2, the slurry composition including the second CMC has a slight difference in the viscosity properties under a condition (up) where the shear rate is relatively increased and a condition (down) where the shear rate is relatively reduced. Unlike the first CMC, the second CMC has large molecules and relatively high viscosity and exists in a mixed form in a powder at a low shear rate and the CMCs are arranged in a mixed form at a high shear rate. As a result, it is determined that the above-mentioned phenomenon occurs. Therefore, when the electrode is manufactured as the slurry composition including the second CMC, the used amount of a separate solvent is increased in order to secure the viscosity of the second CMC. In this case, when the electrode is manufactured, a large amount of moisture is evaporated in the slurry composition and the content of active materials in the electrode is reduced, thereby causing a problem in expressing the capacity of the energy storage device.

### SUMMARY OF THE INVENTION

An object of the present invention is to provide carboxy methyl cellulose capable of improving electrode characteristics of an energy storage device and slurry composition with the same.

Another object of the present invention is to provide carboxy methyl cellulose capable of improving viscosity properties and slurry composition with the same.

According to an exemplary embodiment of the present invention, there is provided carboxy methyl cellulose having a viscosity of 100 to 500 cP in 1 wt % slurry composition.

The carboxy methyl cellulose may have an average molecular weight of 45,000 to 70,000.

The carboxy methyl cellulose may have a degree of substitution of 0.7 to 0.9.

According to an exemplary embodiment of the present invention, there is provided slurry composition including: an activated carbon used as an electrode active material; a conductive material giving conductivity to the slurry composition; and carboxy methyl cellulose having a viscosity of 100 to 500 cP in 1 wt % slurry composition solution.

The carboxy methyl cellulose may have an average molecular weight of 45,000 to 70,000.

The carboxy methyl cellulose may have a degree of substitution of 0.7 to 0.9.

### BRIEF DESCRIPTION OF THE DRAWINGS

FIG. 1 is a diagram showing any one behavior characteristic among slurry compositions for manufacturing an electrode for an energy storage device used in the related art;

FIG. 2 is a diagram showing the other behavior characteristic among slurry compositions for manufacturing an electrode for an energy storage device used in the related art;

FIG. 3 is a diagram showing the behavior characteristics of the slurry composition according to an exemplary embodiment of the present invention;

FIG. 4 is a diagram showing the behavior characteristics of the slurry composition and the carboxy methyl cellulose according to an exemplary embodiment of the present invention; and

FIG. 5 is a diagram comparing the capacity characteristics of the electrode manufactured using the slurry composition according to the related art with the capacity characteristics of the electrode manufactured using the slurry composition according to the exemplary embodiment of the present invention.

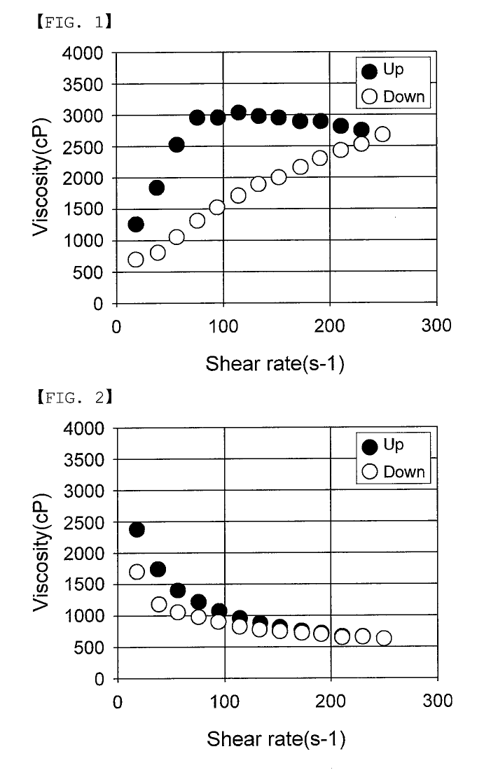

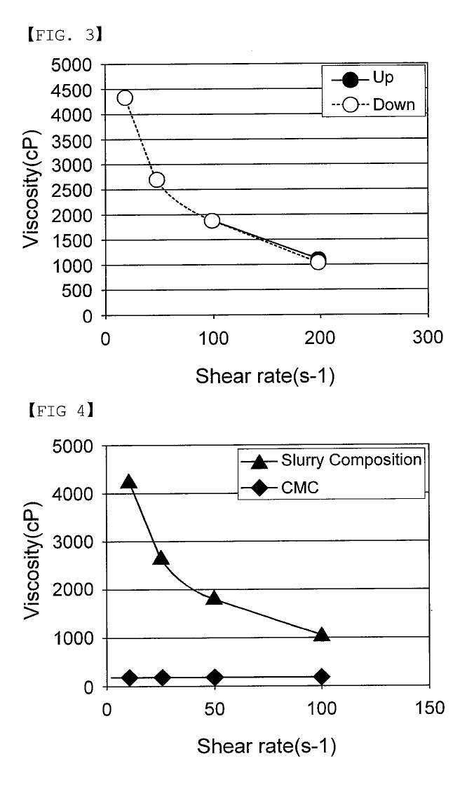

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals in the drawings denote like elements throughout the specification.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, carboxy methyl cellulose and slurry composition with the same according to the present invention will be described in detail.

Slurry composition according to an exemplary embodiment of the present invention may be fluid for manufacturing an electrode for a predetermined energy storage device. For example, the slurry composition may be a solution coated on a metal plate in order to manufacture a rechargeable battery and an electrode for a super capacitor.

The slurry composition may include an activated carbon, a conductive material, and a binder. The activated carbon may be used as an electrode active material. Therefore, the activated carbon can be advantageously used to improve the accumulation of electrode charge amount of the energy storage device, as the surface area of the activated carbon becomes increased. The conductive material may be a material for giving conductivity to the slurry composition. As the conductive material, a carbon-based material having high electric conductivity and various types of metal nano particles may be used.

The binder is provided in order to improve material property of the slurry composition. As an example, the binder may include carboxy methyl cellulose. The carboxy methyl cellulose (hereinafter, referred to as ‘CMC’) may have a viscosity of 100 to 500 cP in 1 wt % slurry composition. Therefore, when the viscosity of the CMC is lower than 100 cP, sediment is generated in the CMC which degrades solution stability and when the slurry composition is coated on the surface of the current collector in order to manufacture the electrode, the phenomenon of the slurry composition occurs in that it is non-uniformly coated on the surface of the current collector. To the contrary, in the case where the viscosity of the CMC is larger than 500 cP, a large amount of solvent should be used in order to secure the viscosity of the CMC when the electrode is manufactured using the slurry composition with the CMC. In this case, a large amount of moisture is evaporated in the slurry composition during the process of manufacturing the electrode, the content of active materials in the electrode is reduced, thereby causing a problem in expressing the capacity of the energy storage device. Therefore, it is preferable that the viscosity of the CMC is controlled to 100 cP to 500 cP.

Further, the CMC according to the present invention may have an average molecular weight of 45,000 to 70,000. Therefore, when the average molecular weight of the CMC is lower than 45,000, sediment is generated in the CMC to degrade solution stability and when the slurry composition is coated on the surface of the current collector in order to manufacture the electrode, the phenomenon that the slurry composition is non-uniformly coated on the surface of the current collector occurs. To the contrary, in the case where average molecular weight of the CMC exceeds 70,000, a large amount of solvent should be used in order to secure the viscosity of the second CMC when the electrode is manufactured using the slurry composition with the second CMC, such that the content of active material in the electrode is reduced during the process of manufacturing the electrode, thereby causing the problem in expressing the capacity of the energy storage device. Therefore, it is preferable that the average molecular weight of the CMC is controlled to 45,000 to 70,000.

Meanwhile, the CMC according to the present invention may have a degree of substitution of 0.7 to 0.9. The degree of substitution may be a numerical value representing the number of substituents of cellulose derivatives of the CMC. When the degree of substitution of the CMC meets 0.7 to 0.9, the characteristics of the electrode manufactured using the slurry composition may be improved.

The electrode for the energy storage device may be manufactured using the above-mentioned slurry composition. As an example, the slurry composition is coated on a metal layer such as aluminum foil and the metal layer coated with the slurry composition may be compressed by a roller. The metal layer may be configured to enclose an electrode rod used as the current collector. The electrode for the energy storage device may be manufactured by drying, cutting, and punching the metal layer. Herein, the above-mentioned slurry composition has excellent viscosity property, such that it may be uniformly distributed over the aluminum foil. The evaporation rate of the slurry composition is low during the drying process, such that the precision and simplicity of the process of manufacturing the electrode may be improved. Therefore, the capacity expression of the energy storage device including the electrode manufactured using the above-mentioned slurry composition can be improved.

As described above, the measuring results of the CMC and the material property of the slurry composition with the same according to the present invention and the characteristics of the electrode manufactured using the slurry composition will be described.

FIG. 3 is a diagram showing the behavior characteristics of the slurry composition according to an exemplary embodiment of the present invention. Referring to FIG. 3, in the slurry composition according to the exemplary embodiment of the present invention, the behavior characteristic (viscosity property) under the condition (up) where the shear rate (rpm) is relatively increased and the behavior characteristic (viscosity property) under the condition (down) where the shear rate is relatively reduced approximately conforms to each other. Therefore, the slurry composition according to the exemplary embodiment of the present invention has solution stability so as not to generate the sediment and when the slurry composition is coated on the current collector in order to manufacture the electrode, has stable material property to uniformly coat the slurry composition over the current collector.

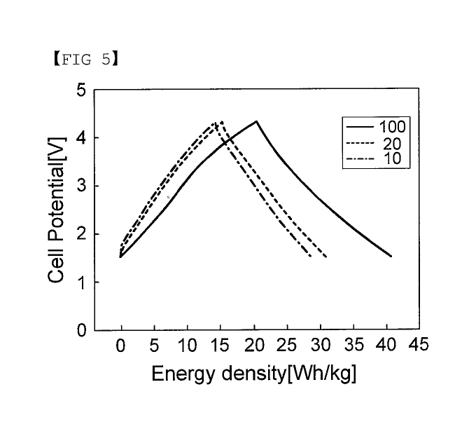

FIG. 4 is a diagram showing the behavior characteristics of the slurry composition and the carboxy methyl cellulose according to an exemplary embodiment of the present invention. Referring to FIG. 4, the carboxy methyl cellulose (CMC) according to the exemplary embodiment of the present invention keeps the uniform viscosity property even when the shear rate is changed. The stability of the slurry composition can be secured due to the viscosity stability of the CMC. Therefore, as described with reference to FIG. 3, in the slurry composition according to the present invention, the behavior characteristic (viscosity property) under the condition (up) where the shear rate (rpm) is relatively increased and the behavior characteristic (viscosity property) under the condition (down) where the shear rate is relatively reduced approximately conforms to each other, thereby making it possible to have the characteristics of a very stable solution.

FIG. 5 is a diagram showing the capacity characteristics of the super capacitor having the electrode manufactured using the slurry composition according to the related art and the capacity characteristics of the super capacitor having the electrode manufactured using the slurry composition according to the exemplary embodiment of the present invention. In FIG. 5, reference numeral 10 is a graph showing the capacity characteristics of the super capacitor having the electrode manufactured using the slurry composition including the first CMC (see the related art) of the related art. Reference numeral 20 is a graph showing the capacity characteristics of the super capacitor having the electrode manufactured using the slurry composition including the second CMC (see the related art) of the related art. Reference numeral 100 is a graph showing the capacity characteristics of the super capacitor having the electrode manufactured using the slurry composition according to the exemplary embodiment of the present invention.

As shown in FIG. 5, the electrode 100 manufactured using the slurry composition according to the present invention has remarkably high energy density per unit weight as compared to the electrodes 10 and 20 according to the related art. Therefore, the slurry composition according to the present invention can increase the capacity expression of the energy storage device.

According to the present invention, the carboxy methyl cellulose may have the viscosity of 100 to 500 cP in 1 wt % slurry composition. The carboxy methyl cellulose prevents sediment from being generated in the slurry composition, thereby making it possible to secure high stability and improve the viscosity properties enabling the process of manufacturing the electrode using the slurry composition. When the electrode for the energy storage device is manufactured using the slurry composition with the carboxy methyl cellulose, the manufacturing efficiency of the electrode can be improved and the capacity expression of the energy storage device can be increased.

According to the present invention, the slurry composition may include carboxy methyl cellulose having the viscosity of 100 to 500 cP in 1 wt % slurry composition. In this case, the slurry composition can secure high stability without generating the sediment and improve the viscosity properties enabling the process of manufacturing the electrode using the slurry composition. As a result, when the electrode for the energy storage device is manufactured using the slurry composition, the manufacturing efficiency of the electrode can be improved and the capacity expression of the energy storage device can be increased.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. Carboxy methyl cellulose of slurry composition for manufacturing an electrode for an energy storage device, wherein the carboxy methyl cellulose has a viscosity of 100 to 500 cP in 1 wt % slurry composition.

2. The carboxy methyl cellulose according to claim 1, wherein the carboxy methyl cellulose has an average molecular weight of 45,000 to 70,000.

3. The carboxy methyl cellulose according to claim 1, wherein the carboxy methyl cellulose has a degree of substitution of 0.7 to 0.9.

4. Slurry composition for manufacturing an electrode for an energy storage device, comprising:
an activated carbon used as an electrode active material;
a conductive material giving conductivity to the slurry composition; and
carboxy methyl cellulose having a viscosity of 100 to 500 cP in 1 wt % slurry composition solution.

5. The slurry composition according to claim 4, wherein the carboxy methyl cellulose has an average molecular weight of 45,000 to 70,000.

6. The slurry composition according to claim 4, wherein the carboxy methyl cellulose has a degree of substitution of 0.7 to 0.9.
